(19) United States
(12) Patent Application Publication
(10) Pub. No.: US 2004/0213650 A1
(43) Pub. Date: Oct. 28, 2004

(54) Bin sweep auger

(76) Inventors: Richard J. Epp, Saskatchewan (CA); Dwayne S. Epp, Saskatchewan (CA)

Correspondence Address: ADE & COMPANY, 1700-360 MAIN STREET, WINNIPEG, MB, R3C3Z3, CA

(21) Appl. No.: 10/819,209

(22) Filed: Apr. 7, 2004

Related U.S. Application Data
(60) Provisional application No. 60/465,275, filed on Apr. 25, 2003.

(51) Int. Cl. B65G 1/00

(52) U.S. Cl. 414/310

(57) ABSTRACT

A discharge system for a grain storage bin has a discharge auger extending from a pit at the center of the bin floor to an exterior location and a sweep auger pivotally supported at an inner end at the center extending across the floor to the periphery of the bin for sweeping movement over the floor. The sweep auger is driven by a chain in a covered guide track arranged around the periphery of the bin wall driven around the bin wall by a motor fixed at one point on the bin wall and driving the chain along its length about the periphery of the bin with a carriage slidably located in the track connected to a flexible coupling connecting the outer end of the sweep auger to the chain to be displaced about the periphery of the bin with the chain.

This application claims priority under 35 U.S.C.119 from Provisional Application 60/465,275 filed Apr. 25, 2003.

### FIELD OF THE INVENTION

The present invention relates to a sweep auger and more particularly to a drive system for a sweep auger of the type typically used in a particulate material storage bin.

### BACKGROUND

In particulate material storage bins it is common practice to provide an auger system for unloading the bin. U.S. Pat. No. 3,356,235 to Laidig; U.S. Pat. No. 3,127,032 to Roberts; U.S. Pat. No. 4,701,093 to Meyer; U.S. Pat. No. 4,619,577 to Swanson; U.S. Pat. No. 6,254,329 to Sukup et al; and U.S. Pat. No. 4,669,941 to West et al disclose variations of sweeping augers for use in particulate material storage bins. In each instance sweeping movement of the auger about the bin floor either is dependent upon the rotation speed of the auger about its respective longitudinal axis or requires a complex mechanism to separately drive rotation and sweeping movement of the auger from a central connection within the bin. Furthermore the bin sweeps are typically not configured for use with a conventional unloading takeout auger and accordingly cannot be positioned closely and parallel to the takeout auger for fully sweeping the bin floor.

### SUMMARY

According to one aspect of the present invention there is provided a storage bin for particulate material having a discharge system for discharging the material from the bin comprising:

a storage bin having a bin floor and a generally cylindrical bin wall upstanding from the floor;

a discharge apparatus for discharging material from a center of the bin floor to an exterior location;

a sweep auger pivotally supported at an inner end of the sweep auger adjacent the center of the bin and extending therefrom across the floor to an outer end for movement of the outer end of the sweep auger about a periphery of the bin for sweeping movement of the sweep auger over the floor,

and a drive system for driving movement of the sweep auger comprising;

a guide track arranged around the periphery of the bin wall;

an elongate driven member located by the guide track and extending around the periphery;

a motor for driving movement of the driven member along its length about the periphery of the bin; and

a coupling for connecting the outer end of the sweep auger to the driven member to be displaced about the periphery of the bin with the driven member.

Preferably the guide track includes an annular housing about the periphery of the bin for receiving the annular driven member therein.

Preferably the housing is sealed with respect to the bin wall at a top side thereof.

Preferably the housing has a top side thereof covered by an inclined surface to shed particulate material from the top of the housing.

Preferably the guide track is supported above the floor of the bin and supports the annular driven member thereon.

Preferably there is provided a carriage slidably supported on the track.

Preferably the carriage is slidable by sliders formed of low friction material.

Preferably the annular driven member comprises an endless chain driven along its length about the bin by at least one chain wheel driven by the motor. Other endless members such as a cable or belt could also be used.

Preferably the motor is located at a fixed position on the bin wall and drives the driven member along its length so that the driven member moves around the wall.

Preferably there is provided a discharge auger extending from a central collection area to an exterior of the bin and wherein the sweep auger is mounted on a coupling link at its inner end which is arranged so as to allow the sweep auger to move radially around the bin and to positions on each side of the discharge auger at which positions it is parallel to and side by side with the discharge auger and thus deviated from the radial position.

Preferably the coupling link comprises a link member which is pivotally mounted on a vertical center axis of the bin and is pivotally connected about a vertical pivot axis to the sweep auger such that cranking of the link accommodates length changes between the outer end of the sweep auger and the center axis.

The invention relates primarily to the bin when assembled with the discharge system, but it will be appreciated that one aspect of the invention relates also to the sweep auger assembly alone prior to assembly which is designed and arranged for use in the storage bin for particulate material having a bin floor and a generally cylindrical bin wall upstanding from the floor and a discharge apparatus for discharging material from a center of the bin floor to an exterior location, the sweep auger assembly comprising:

a sweep auger arranged to be pivotally supported at an inner end of the sweep auger for location adjacent the center of the bin so as to extend therefrom across the floor to an outer end for movement of the outer end of the sweep auger about a periphery of the bin for sweeping movement of the sweep auger over the floor,

and a drive system for driving movement of the sweep auger comprising;

a guide track arranged to be mounted around the periphery of the bin wall;

an elongate driven member arranged to be located by the guide track and extending around the periphery;

a motor for driving movement of the driven member along its length about the periphery of the bin; and

a coupling for connecting the outer end of the sweep auger to the driven member to be displaced about the periphery of the bin with the driven member.

The use of an annular driven member at a periphery of the bin permits control of the rate of sweeping movement of the auger separately from rotation thereof about its respective longitudinal axis using a mechanism of low cost and simple construction. The addition of a telescoping arm to attach the sweeping auger to the annular driven member at the periphery of the bin permits the auger to be offset from a radial direction extending from the center of the bin so that the sweeping auger can be positioned parallel and adjacent to the takeout auger for maximum coverage of the bin floor while sweeping.

### BRIEF DESCRIPTION OF THE DRAWINGS

In the accompanying drawings, which illustrate an exemplary embodiment of the present invention:

FIG. 1 is top plan view of a bin sweep drive system installed in a conventional particulate material storage bin.

FIG. 2 is a partly sectional side elevational view of the sweep auger connected to the drive system at the periphery of the bin.

FIG. 3 is a partly sectional top plan view of the outer end of the sweep auger connected to the drive system at the periphery of the bin.

FIG. 4 is a top plan view on an enlarged scale of the center section of the bin showing the sweep auger in three separate positions through which it moves in its sweeping action.

FIG. 5 is a side elevational view of the center section of the sweep auger showing the connecting link.

### DETAILED DESCRIPTION

Referring to the accompanying drawings, there is illustrated a bin sweep system generally indicated by reference numeral 10. The bin sweep system is particularly suited for cleaning out particulate material storage bins, for example the type for storing seed and the like in agricultural applications. The bin 12 includes a central clean out pit 14 which receives the loading end of a takeout auger 16 therein. The takeout auger 16 is received through a door of the bin for unloading the bin from a center thereof. The sweep system 10 assists in cleaning out leftover particulate material on the floor 18 by urging the material towards the center pit 14 of the bin.

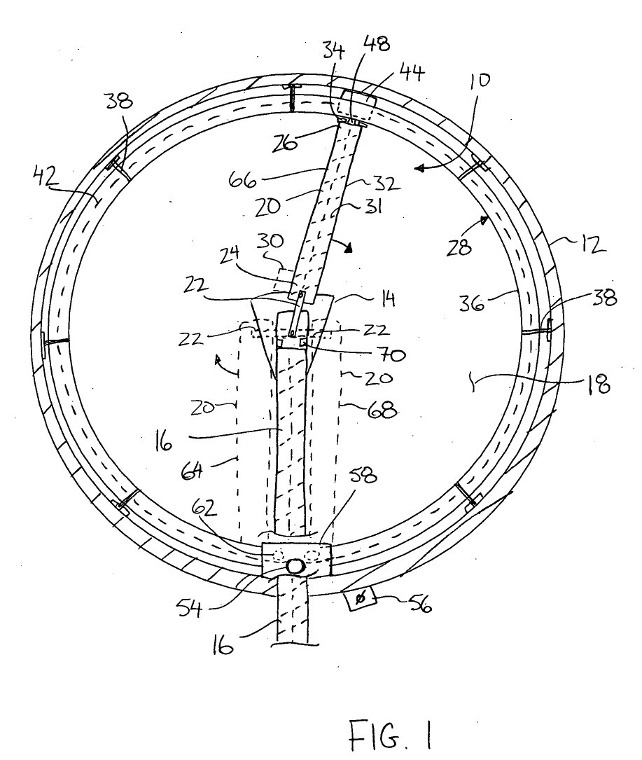

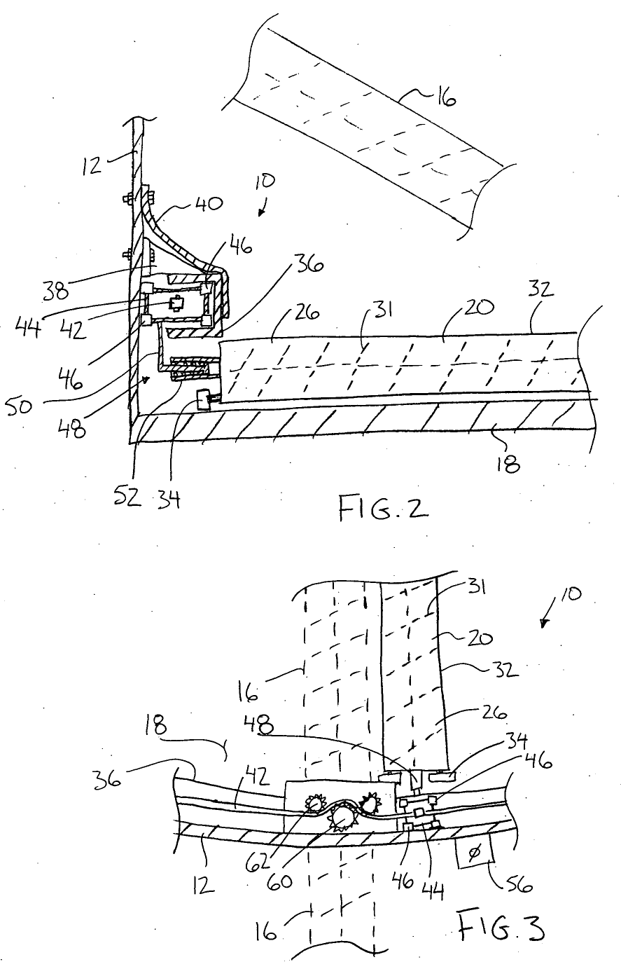

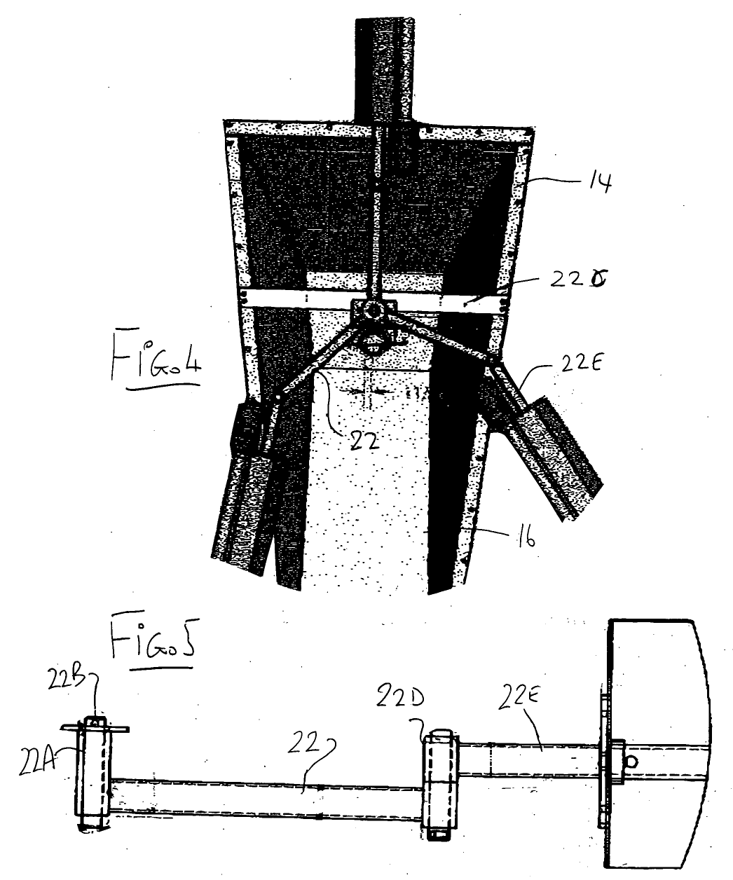

The bin sweep system 10 includes a sweep auger 20 which is supported for sweeping movement about a center of the bin. A connecting link 22 is provided which is pivotally supported at a first end at the center of the bin 12 and is pivotally connected at a second end on the inner end 24 of the sweep auger 20. Further detail of the connecting link 22 is shown in FIGS. 4 and 5 where it will be noted that the inner end of the link 22 is pivoted on a collar 22A carried on a pin 22B mounted on a strap 22C across the pit 14. An outer end of the link 22 is connected to a pivot coupling 22D which is connected to a mounting bar 22E rigidly attached to the sweep auger 20. Thus as shown in FIG. 1 the double pivot coupling provided by the link and its connections allows the sweep auger to move in a circle while remaining mainly on a radius with the link 22 on the same radius but also allows the sweep auger to move from a radial position to a position parallel to and alongside the radial auger 16. It will be appreciated that this deviation from a radial position changes the length between the outermost end of the sweep auger and the center pivot pin 22B. This change in length can be provided by cranking the link 22 at an angel to the radius so that the angle between the auger 16 and the link 22 provides the difference from the radial distance

An outer end 26 of the sweep auger 20 is coupled to an auger sweep drive 28 at a peripheral wall of the bin. The sweep auger 20 is rotated about a respective longitudinal axis thereof by a hydraulic motor 30 coupled to flighting of the auger at an inner end 24 of the auger. The sweep auger 20 further includes a housing 32 which partially encloses the flighting 31 of the auger as in a typical housing for a sweeping auger in a particulate material storage bin. A pair of wheels 34 are supported on the housing 32 at the outer end 26 thereof to support the auger for rolling movement on the bin floor 18.

The auger sweep drive 28 includes an annular housing or track 36 which is supported about an inner surface of the peripheral wall of the bin. The housing 36 generally comprises a channel of U-shaped cross section in which an open side of the channel faces outwardly towards the peripheral bin wall. A plurality of brackets 38 are provided at circumferentially spaced locations about the housing 36 to support the channel forming the housing on the bin wall at a spacing from the wall. An optional sealing member 40 can be provided which spans the spacing between a top edge of the housing 36 and the bin wall. The sealing member 40 generally comprises a tarp of pliable material which is fastened to the peripheral wall of the bin in sealing engagement therewith directly above the housing 36 such that the tarp drapes over the housing to terminate at a lower free end suspended adjacent a radially inwardly facing surface of the housing. The tarp can be omitted for simplicity.

The housing 36 receives an endless chain 42 which extends through the housing 36 about a full periphery of the bin. The housing further receives a carriage 44 in the form of a rigid block of material supporting a plurality of low friction sliders 46 thereon such that the carriage is supported for sliding movement about the periphery of the bin within the interior of the housing. The carriage 44 is suitably sized to fit between the peripheral wall of the bin and the interior of the channel forming the annular housing 36. The carriage 44 mounts one or more links of the annular chain 42 thereon such that the carriage 44 and the chain are moveable together about the periphery of the bin. Various different arrangements of the carriage can be provided and one suitable arrangement includes a simple formed plastic block which provides a the structure and the sliding surfaces.

A pull arm 48 couples the outer end of the sweep auger to the carriage 44 for movement together with the chain. The pull arm includes an upright portion 50 which is received through a space between a bottom edge of the annular housing 36 and the bin wall. The upright portion connects to an optional telescoping portion 52 which is slidably adjustable in length and spans between the upright portion and the outer end of the auger. The telescoping portion 52 is spring loaded so as to be biased in a direction which urges the telescoping portion to be retracted to urge the auger towards the annular housing. The telescoping portion is not essential since the changes in length can be provided by the cranking of the link 22.

Rotation of the chain 42 about the bin is driven by a hydraulic drive motor 54 which is supported at a periphery of the bin adjacent the bin door so as to be located directly below the takeout auger 16. The drive motor 54 includes a flow control valve 56 coupled to the hydraulic flow lines of the motor for controlling the drive rate of the motor as desired. A drive housing 58 is provided for receiving a main drive gear 60 therein which meshes with an outwardly facing side of the chain 42. Two idler gears 62 mesh with a radially opposing inner side of the chain 42 on circumferentially opposing sides of the drive gear 60 to ensure constant meshing of the endless chain 42 with the main drive gear. In this arrangement the flow control valve 56 is used to adjust output of the drive motor 54 which rotates the main drive gear 60 to control the speed of rotation of the chain 42 about the periphery of the bin and accordingly control the rate at which the sweep auger is rotated about the center of the bin with the chain.

In use, the sweep auger is first positioned directly adjacent the takeout auger, parallel thereto as viewed from above in FIG. 1 in dotted line in the starting position 64. In the starting position, the inner end is positioned adjacent the inner end of the takeout auger by orienting the pivot arm 22 perpendicularly to both the sweep auger 20 and takeout auger 16. Also in the starting position 64 the telescoping portion 52 of the pull arm 48 is extended under spring tension. Starting the drive motor 54 by use of the flow control valve 56 begins rotation of the chain about the periphery of the bin within the annular housing 36 of the sweep drive. The pivot arm 22 remains abutted against a stop 70 until the sweep auger has been rotated through 90 degrees of rotation about the bin floor.

Through connection of the pull arm 48, the sweep auger rotates with the chain towards an intermediate sweep position 66 shown in solid line in FIG. 1. In the intermediate sweep position, the pivot arm 22 lies parallel to the longitudinal direction of the sweep auger due to spring action of the telescoping portion 52 of the pull arm 48 which urges the sweep auger radially outwardly to maintain alignment of the pivot arm 22 with the longitudinal axis of the sweep auger during sweeping action thereof. In the sweep position 66, the sweep auger rotates through 180° until the pivot arm 22 engages a further stop 70 positioned to limit further pivoting of the pivot arm 22 relative to the longitudinal direction of the takeout auger beyond a point at which the angle is less than 90° therebetween.

For the remaining 90° of rotation of the sweep auger about the bin floor, the pivot arm remains engaged on the stop 70 while the sweep auger continues to rotate into a parallel orientation in the end position 68 shown in dotted line of FIG. 1 and in greater detail in FIG. 3. The telescoping arm extends under spring tension such that the outer end of the sweep auger remains connected to the carriage 44 on the chain 42.

The flow control valve 56 can be adjusted at any time to ensure that the sweep auger is swept about the bin floor at an optimal rate independent of the rate of rotation of the auger about its respective longitudinal axis.

While one embodiment of the present invention has been described in the foregoing, it is to be understood that other embodiments are possible within the scope of the invention. For example, in further embodiments, the chain and gears of the sweep drive may be replaced by any suitable pulley and cable configuration or a variation of different track designs in which an annular member is driven to rotate about the periphery of the bin. The invention is to be considered limited solely by the scope of the appended claims.

1. A storage bin for particulate material having a discharge system for discharging the material from the bin comprising:
a storage bin having a bin floor and a generally cylindrical bin wall upstanding from the floor;
a discharge apparatus for discharging material from a center of the bin floor to an exterior location;
a sweep auger pivotally supported at an inner end of the sweep auger adjacent the center of the bin and extending therefrom across the floor to an outer end for movement of the outer end of the sweep auger about a periphery of the bin for sweeping movement of the sweep auger over the floor,
and a drive system for driving movement of the sweep auger comprising;
a guide track arranged around the periphery of the bin wall;
an elongate driven member located by the guide track and extending around the periphery;
a motor for driving movement of the driven member along its length about the periphery of the bin; and
a coupling for connecting the outer end of the sweep auger to the driven member to be displaced about the periphery of the bin with the driven member.

2. The storage bin according to claim 1 wherein the guide track includes an annular housing about the periphery of the bin for receiving the annular driven member therein.

3. The storage bin according to claim 2 wherein the housing is sealed with respect to the bin wall at a top side thereof.

4. The storage bin according to claim 2 wherein the housing has a top side thereof covered by an inclined surface to shed particulate material from the top of the housing.

5. The storage bin according to claim 1 wherein the guide track is supported above the floor of the bin and supports the annular driven member thereon.

6. The storage bin according to claim 5 wherein there is provided a carriage member slidably supported on the track.

7. The storage bin according to claim 5 wherein the carriage member is slidable by sliding surfaces formed of low friction material.

8. The storage bin according to claim 1 wherein the annular driven member comprises an endless chain driven along its length about the bin by at least one chain wheel driven by the motor.

9. The storage bin according to claim 8 wherein the motor is located at a fixed position on the bin wall and drives the driven member along its length so that the driven member moves around the wall.

10. The storage bin according to claim 1 wherein there is provided a discharge auger extending from a central collection area to an exterior of the bin and wherein the sweep auger is mounted on a coupling link at its inner end which is arranged so as to allow the sweep auger to move radially around the bin and to positions on each side of the discharge auger at which positions it is parallel to and side by side with the discharge auger and thus deviated from the radial position.

11. The storage bin according to claim 10 wherein the coupling link comprises a link member which is pivotally mounted on a vertical center axis of the bin and is pivotally connected about a vertical pivot axis to the sweep auger such that cranking of the link accommodates length changes between the outer end of the sweep auger and the center axis.

12. A sweep auger assembly for use in a storage bin for particulate material having a bin floor and a generally cylindrical bin wall upstanding from the floor and a discharge apparatus for discharging material from a center of the bin floor to an exterior location, the sweep auger assembly comprising:
a sweep auger arranged to be pivotally supported at an inner end of the sweep auger for location adjacent the center of the bin so as to extend therefrom across the floor to an outer end for movement of the outer end of the sweep auger about a periphery of the bin for sweeping movement of the sweep auger over the floor,
and a drive system for driving movement of the sweep auger comprising;
a guide track arranged to be mounted around the periphery of the bin wall;
an elongate driven member arranged to be located by the guide track and extending around the periphery;
a motor for driving movement of the driven member along its length about the periphery of the bin; and
a coupling for connecting the outer end of the sweep auger to the driven member to be displaced about the periphery of the bin with the driven member.

13. The sweep auger assembly according to claim 12 wherein the guide track includes an annular housing about the periphery of the bin for receiving the annular driven member therein.

14. The sweep auger assembly according to claim 13 wherein there is provided a seal for the housing with respect to the bin wall at a top side thereof.

15. The sweep auger assembly according to claim 12 wherein there is provided an inclined surface for the housing at a top side thereof to shed particulate material from the top of the housing.

16. The sweep auger assembly according to claim 12 wherein there is provided a carriage arranged to be slidably supported on the track.

17. The sweep auger assembly according to claim 16 wherein the carriage is slidable by sliders formed of low friction material.

18. The sweep auger assembly according to claim 12 wherein the annular driven member comprises an endless chain driven along its length about the bin by at least one chain wheel driven by the motor.

19. The sweep auger assembly according to claim 12 wherein there is provided a discharge auger extending from a central collection area to an exterior of the bin and wherein the sweep auger is mounted on a coupling link at its inner end which is arranged so as to allow the sweep auger to move radially around the bin and to positions on each side of the discharge auger at which positions it is parallel to and side by side with the discharge auger and thus deviated from the radial position.

20. The sweep auger assembly according to claim 19 wherein the coupling link comprises a link member which is pivotally mounted on a vertical center axis of the bin and is pivotally connected about a vertical pivot axis to the sweep auger such that cranking of the link accommodates length changes between the outer end of the sweep auger and the center axis.
